(19) United States
(12) Patent Application Publication
(10) Pub. No.: US 2011/0152734 A1
(43) Pub. Date: Jun. 23, 2011

(54) DEVICE FOR PNEUMATIC TREATMENT OF AN INFERIOR LIMB HAVING PERIPHERAL ARTERIOPATHY PROBLEMS

(76) Inventors: Paolo Zamboni, Ferrara (IT); Fabio Manfredini, Ferrara (IT)

(21) Appl. No.: 13/003,155

(22) PCT Filed: Jul. 7, 2008
(86) PCT No.: PCT/IT08/00454

§ 371 Date: Feb. 17, 2011

(51) Int. Cl. A61H 7/00

(52) U.S. Cl. 601/134

(57) ABSTRACT

A device (1) for compression treatments of an inferior limb (A) of a subject, said device (1) comprising an inflatable element (2) apt to being placed in contact with a portion of said inferior limb (A) to exert an action of compression and decompression on said portion of inferior limb (A), wherein the inflatable element (2) includes a rigid element (3), positionable on the medial part of the thigh of the subject for compression of the internal femoral vein.

### FIELD OF THE INVENTION

The present description concerns a device for compression treatments of an inferior limb of a subject affected by peripheral arteriopathy with consequent problems of relative or critical ischemia.

### TECHNOLOGICAL BACKGROUND

Intermittent pneumatic compression (CPI) is a technique based on the application of a pressure at the level of various points of the inferior limb, aimed at provoking haemodynamic modifications starting from the treatment zone.

The MeSH 2007 definition of CPI instruments considers them capable of generating uniform or graduated intermittent forces, facilitating venous emptying. According to such definition these instruments are used to reduce oedema and prevent venous thromboembolism, such as deep vein thrombosis of the inferior limbs.

However, the haemodynamic modifications produced by CPI appear to be various and complex. At the level of the circulatory district it is believed that CPI provokes a distension of the epithelial cells of the artery and an increase of sheer stress. This would be followed by an greater production of nitric oxide and an increase in circulating prostacyclins, with inhibition of platelet aggregation and smooth muscle cell contraction. The final result would be a vasodilatation action and an increase in perfusion. At the level of skeletal muscle, it is believed that the elicited increase in contraction is responsible for an increase of the arterio-venous gradient and of arterial flow and of a decrease in venous pressure and peripheral stagnation (1). Finally, the increase in interstitial pressure at the subcutaneous level could favour a re-entrance into circulation of interstitial fluids.

The interest at the international level for such technique has grown progressively. CPI is mainly used in the area of venous-lymphatic pathologies in particular for the prevention of deep vein thrombosis (DVT) and for the treatment of stasis ulcers.

However, the possible haemodynamic modifications obtainable by CPI have led to the study of the effects of the application of such methodology also to arterial pathologies.

Several authors have documented the efficacy of CPI treatment in patients affected by peripheral arteriopathy, in which an improved venous return and the lowering of venous pressure induced by CPI would allow obtainment of an increase in the arterio-venous pressure gradient with an increase of arterial blood at the extremities of the inferior limbs (1).

The efficacy of CPI therapy was underscored in a study on 25 subjects affected by peripheral arteriopathy Fontaine stage II with intermittent claudication. In fact, after 4 months of treatment a 100% increase in the claudication distance, of 110% in the ankle-brachial index (ABI) index and a 36% increase in arterial flow with respect to control subjects was registered, benefits persisting even at one year after the end of the treatment.

According to some authors, the optimal therapy in such patients foresees an ideal compression of 120-140 mmHg, with a frequency of 3-4 impulses per minute. Such cycle is considered ideal for obtaining favourable hemodynamic and performance results in subjects with claudicans and for attempting to slow the disease evolution towards conditions of critical ischemia of the inferior limbs in subjects not surgically treatable. Such condition, derived from a blood supply that is not sufficient for tissue nourishment at the most distal parts of the inferior limbs, is accompanied by severe tissue damage that can evolve into ulcer formation with the risk of gangrene and the need for amputation.

Therefore, some authors tried, by means of the use of intermittent pneumatic compression, to create a stimulus capable of reducing the vascular resistances of the small peripheral vessels, which are stably and abnormally dilated in these subjects. By studying 20 legs at Fontane stage III and IV, following the application of CPI applied at the level of the foot and calf with a compression sequence of the two districts at a distance of about two seconds, an increase in the collateral circuits and of the blood flow at the distal districts were observed (2).

Furthermore, the CPI treatment with cuffs positioned in one or more locations, was found to be useful in accelerating the arterial ulcer healing processes and in postoperative settings for prevention of closure of infrainguinal bypass, with increase of the inflow at the level of the calf vessels and decrease in peripheral resistances (3, 4).

From the technical point of view, the CPI instruments are generally constituted by a pneumatic and mechanical pump composed of a pneumatic impulse generator and by an inflatable plastic unit surrounding the treatment area (thigh, calf or foot) (5). However, few instruments are destined for arterial use.

### SUMMARY OF THE INVENTION

Although the devices currently commercially available allow for good results to be achieved in the treatment of inferior limbs of patients to reduce oedema and prevent venous thromboembolism, the need is felt to have devices available that allow an improvement in arterial perfusion at the microcirculatory level, with consequent improvement of oxygen exchange, acting through a reduction of the pressure gradient with the venous component.

The object of the present invention is to provide such device.

According to the present invention, the above said object is achieved by means of the device specifically recalled in the claims that follow, which form an integral part of the present invention.

An embodiment of the invention concerns a device particularly efficacious for allowing an adequate and targeted venous and arterial compression and, in particular, an adequate and targeted compression of the superficial femoral vein, and/or the deep veins of the femoral popliteal segment.

The device object of the present description allows treatment of patients with critical ischemia of the inferior limbs, allowing improvement of the arterio-venous gradient, favouring the drainage of blood from the congested and hypoxic peripheral districts and facilitating arterial inflow. Such actions are useful for increasing perfusion of the microcirculatory unit.

### BRIEF DESCRIPTION OF THE ANNEXED FIGURES

The invention will now be described in detail by way of non-limiting example only, with reference to the annexed figures, in which:

FIGS. 1a, 1b and 1c schematically illustrate one embodiment (a) of the device object of the present description in its entirety, (b) a prospective view and (c) a view in section of the inflatable element.

FIGS. 2a, 2b and 2c respectively represent (a) trend in time of the parameters detected in the patient by the instrument Oxysoft MKIII (NIRS methodology) during CPI with an intermittent operative cycle applied to a limb, (b) the trend in time of oxygenated haemoglobin after normalisation to zero and statistical analysis performed by calculation of the area under the curve and (c) quantification of the perfusion area. The images report the data relative to 5 minutes working of an intermittent cycle.

FIG. 3 represents the trend of the mean blood flow (affected subjects, 7 observations) of the femoral vein detected by Eco-Color-Doppler methodology during a continuous operative cycle. The values refer to the basal condition (1) and to the different phases of the cycle of the actuator device (2) after the first two seconds of compression; (3) total compression; (4) total decompression;

FIGS. 4a and 4b respectively represent the mean perfusion area observed in healthy (4 observations) and affected (7 observations) subjects during a continuous operative cycle. (1) Basal level; (2) 10^{th} min; (3) 15^{th} min; (4) 20^{th} min;

FIG. 5 illustrates the trend in mean blood flow (affected subjects, 11 observations) in the femoral vein detected by Eco-Color-Doppler methodology during an intermittent operative cycle. The values refer to the basal condition (1) and to the different phases of the cycle of the actuator device (2) after the first two seconds of compression; (3) total compression; (4) total decompression

FIG. 6 illustrates the mean perfusion area observed in affected subjects (11 observations) during an intermittent operative cycle. (1) basal level; (2) first working period; (3) second working period; (4) third working period. *P=0.05;

FIG. 7 represents the mean area of O₂ extraction observed in affected subjects (11 observations) during an intermittent operative cycle. (1) basal level; (2) first working period; (3) second working period; (4) third working period.

### DETAILED DESCRIPTION OF EXAMPLES OF EMBODIMENT

In the description that follows various specific details are illustrated with the aim of a detailed comprehension of the embodiments. The embodiments can be realised without one or more of the specific details, or with other methods components materials, etc. In other cases, known structures, materials or operations are not shown or described in detail to avoid obscuring the various aspects of the embodiments.

Reference to “one embodiment” or “an embodiment” in this description indicates that a particular configuration, structure or characteristic described in relation to the embodiment is included in at least one embodiment. Thus, the appearance of the phrases “in one embodiment” or “in an embodiment” possibly present in different places throughout this description do not necessarily all refer to the same embodiment. Furthermore, particular features, structures or characteristics may be combined in any suitable manner in one or more embodiments.

The headings provided herein are for convenience only and thus do not interpret the field of protection or the scope of the embodiments.

One embodiment of the solution described herein concerns a new device for compression treatments of at least one inferior limb constituted of a flexible element, inflatable, also called a cuff, connected to a compressor capable of producing variable and periodic pressures. Unlike the commercially available instruments, which foresee actuator devices for the foot and/or calf, the location of compression foreseen is the thigh. The cuff therefore was designed in a rectangular shape, high enough to be better adapted to the conformation of the limb and provided with a partial rigid support having a length of 10 cm and a width of 10 cm to allow an adequate and targeted compression of the femoral vein. The cycle of the device was set to 20 seconds of compression and 40 seconds of decompression on the basis of the presupposed haemodynamics. An additional innovative aspect is the presence of a manual electromechanical timer capable of modifying the times of work/pause of the instrument.

The device described herein is destined to the treatment of patients with critical ischemia of the inferior limbs, and allows incrementing the arterio-venous gradient, favouring the efflux of blood from congested and hypoxic peripheral districts and facilitating arterial inflow, in this way increasing the perfusion of the microcirculatory unit.

The device is destined to obtain such hemodynamic effects by means of the application of periodic compressions at the level of the venous vessels of the thigh, in particular to the superficial femoral vein and/or to the deep veins of the femoral popliteal segment.

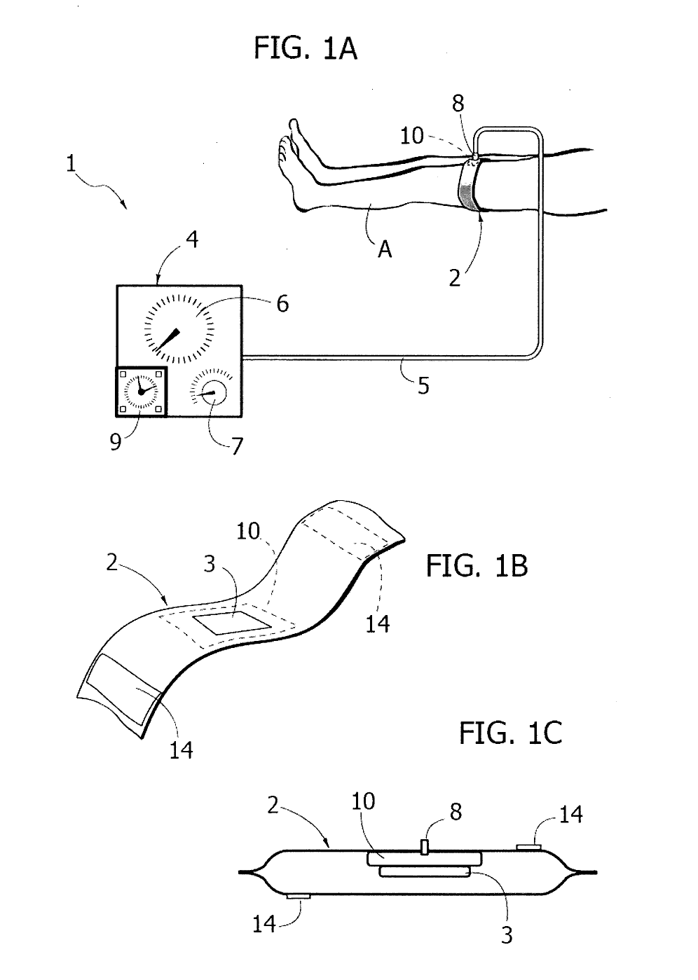

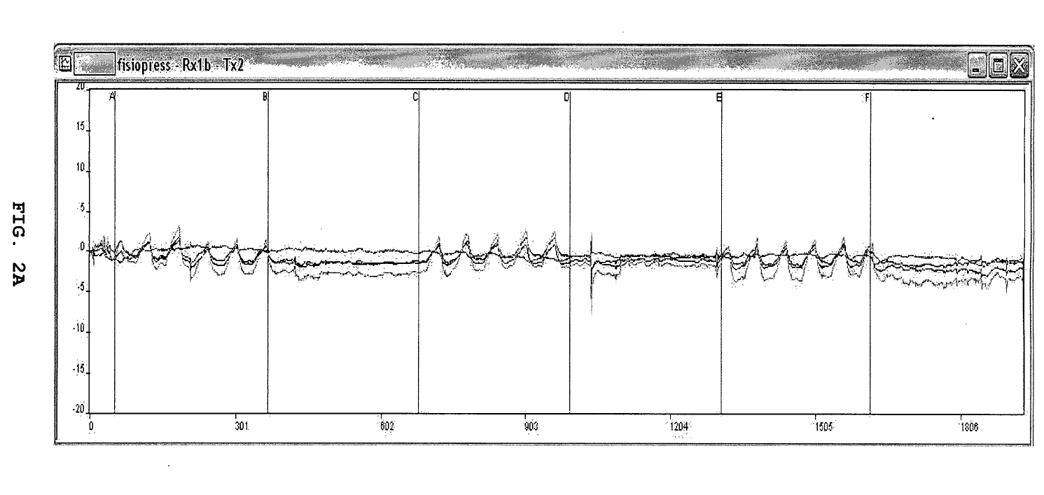

With reference to FIGS. 1a, 1b and 1c the device for compression treatments of an inferior limb of a subject, indicated in its entirety with the numerical reference 1, comprises at least one inflatable element 2 apt to be place in contact with a portion of the inferior limb A of the subject for exerting a compression action on the inferior limb A, in particular on the thigh.

The inflatable element 2 is preferably constituted by a rectangular plastic cuff and comprises an air chamber 10 and a rigid element 3. The inflatable element 2 is additionally provided with closure means 14, for example Velcro type, for placement of the inflatable element 2 on the limb A and maintaining the correct position of the same inflatable element on the limb. The inflatable element 2 is positioned in a location mid thigh on the subject, so that the rigid element 3 is itself—positioned on the upper part of the thigh of the subject to permit an adequate compression of the superficial femoral vein, and/or of the deep veins of the femoral popliteal segment of the limb A.

The rigid element 3, having a length of 7-15 cm, preferably 10 cm, and a width of 7-15 cm, preferably 10 cm, is capable of exerting a compression on the limb A by means of the air chamber 10 to which it is associated, which is located over it when the inflatable element 2 is applied to the limb A.

The air chamber 10 has reduced dimensions with respect to the overall dimensions of the inflatable element 2, so that no pressure is applied to the limb A outside of the part occupied by the air chamber 10 and the rigid element 3.

The device 1 comprises a compressor 4 for supplying the compression fluid, preferably constituted by air, to the air chamber 10. Supply of the compression fluid to the air chamber 10 occurs through a fluid connector 5 that provides a fluid connection between the compressor 4 and the air chamber 10 so that the air chamber 10 can exert the desired compression on the thigh by means of the rigid element 3 associated to it and, in particular, on the superficial femoral vein, and/or on the deep veins of the femoral popliteal segment of the subject.

The compressor 4 is provided with a pressure sensor 6, preferably in the form of a sphygmomanometer, for measuring the flow of compression fluid delivered to the air chamber 10, and consequently the pressure exerted by the inflatable element 2 on the thigh, and with means for controlling the delivery 7 of compression fluid to the air chamber 10.

The inflatable element 2 is provided with a fitting 8, apt to connect it in fluid communication with the fluid connector 5, to allow the entrance and exit of compression fluid inside of the air chamber 10 associated to the rigid element 3, in this way operating the phases of compression and decompression of the limb A.

The device 1 comprises further means for regulation of the timing 9 of compression and decompression of the inflatable element 2, preferably in the form of a manual electromechanical timer.

### Materials and Methods

### Subjects

In total 10 subjects with peripheral vascular pathology at Fontaine stage III-IV (ABI<0.04 and/or trophic lesions) and 2 healthy subjects were evaluated, for a total of 22 limbs measured or observations.

### Measurements Made for Validation of the Device

For all subjects Ankle-Brachial Index (ABI) was measured using standard methods, resting and at the end of the operative cycle.

In addition, two instrumental measurement methodologies were used, effected contemporaneously and always by the same operator. The measurements were performed on the subject in a clinostatic position, before, during and at the end of an operative cycle.

### 1) Eco-Color-Doppler Methodology

A Technos MP instrument (Esaote Biomedics, Genoa, Italy) was used with a 7.5 MH probe. The velocity and capacity of the flow in the femoral vein at the inguinal level were measured. The measurements during the operative cycle were made after 10 minutes of continuous cycle and in the second working period of the intermittent cycle. Relative to the cycle of the actuator device the measurements were performed a) after the first two seconds of compression b) at total compression c) at total decompression.

### 2) NIRS (Near Infrared Spectroscopy) Methodology

An Oxymon MK III, Artinis Medical Systems (Netherlands) was used. NIRS methodology is a non-invasive diagnostic technique that functions in real time, capable of measuring tissue perfusion by evaluating the variations in oxygenated and deoxygenated haemoglobin. The sensors were positioned at the level of the pedidia artery.

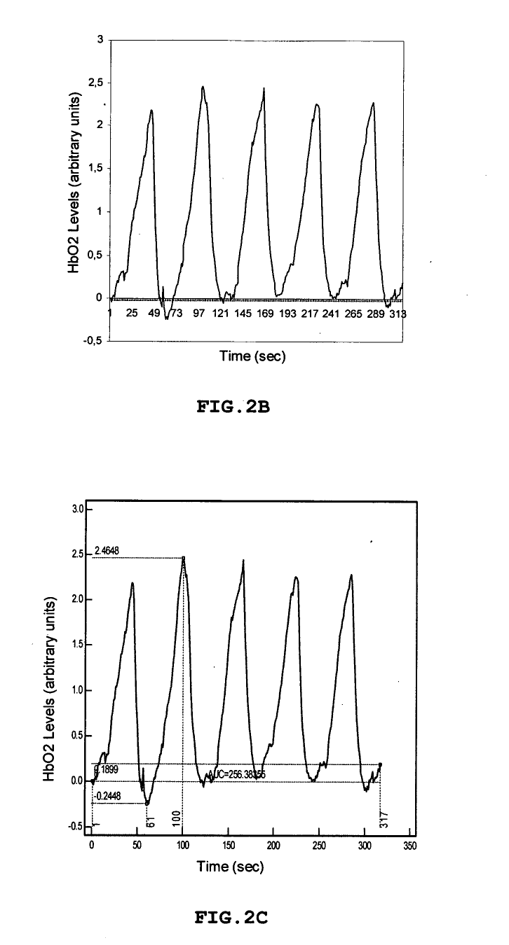

At the end of the operative cycle the semi quantitative data obtained in function of time by the Oxysoft 47 software (Artinis Medical System, Netherlands) (FIG. 2a) were extracted and transferred to an spreadsheet (Excel). After normalisation to zero (FIG. 2b) the data were analysed with a statistics software (Medcalc 8.0, Medcalc Software, Mariakerke, Belgium) for the determination of the area under the curve (FIG. 2c).

Thus it was possible to quantify individual variations in oxygenated, deoxygenated and differential haemoglobin (HBO₂, HHBO₂ and HB differential between HBO₂, HHBO₂) by the creation of areas of perfusion, extraction and of delta perfusion-extraction.

### Phases of the Study

### Phase 1

### a) The Device in Continuous Operative Cycle

The first operative cycle proposed and subjected to experimentation was a continuous cycle of intermittent pneumatic compression for a duration of 20 min. A compression of 120 mmHg was used for all subjects. The measurements were performed in the second half of the cycle, at the 10^{th} minute, at the 15^{th} minute and at the 20^{th} minute.

Such cycle was administered to healthy and affected subjects for a total of 4 and 7 observations, respectively.

### b) The Device in Continuous Operative Cycle Vs a Commercially Available Traditional Instrument

The effects of the device according to the present invention operating in continuous cycle and of a commercially available traditional CPI device were measured in the same subjects (2 observations). The traditional instrument is constituted of a compression sleeve to be positioned at the level of the calf and supplied a graduated and sequential pressure of 95 mmHg at the distal level followed after 3 seconds by a pressure of 85 mmHg at the proximal level. The cycle of the present device foresees 2 seconds of compression and 20 seconds of decompression.

The device was applied for 20 minutes consecutively. The measurements were performed on the subject in a clinostatic position, before, during and at the end of an operative cycle.

### Phase 2

The Device with Intermittent Operative Cycle

On the basis of the data collected in the preceding phase an intermittent operative cycle 1:1 was then tested, based on 5 min work cycles followed by rest phases of the same duration for a total of 15 min of work. The delivery pressure and cycle of the device according to the present description were maintained constant with respect to phase 1.

Eleven observations were performed in affected subjects.

### Results

### Phase 1

### a) The Device in Continuous Operative Cycle

The instrumentation was well tolerated by all subjects, non of whom reported negative sensations.

### Comparisons of Healthy and Affected Subjects

### ABI

In healthy subjects (n=2) a resting ABI value of 1.1±0.1 was recorded, which remained unmodified after the operative cycle.

Analogous result were observed relative to the affected subjects (n=4) who showed an average ABI value of 0.55±0.20 both resting and after the operative cycle.

### Eco-Color-Doppler

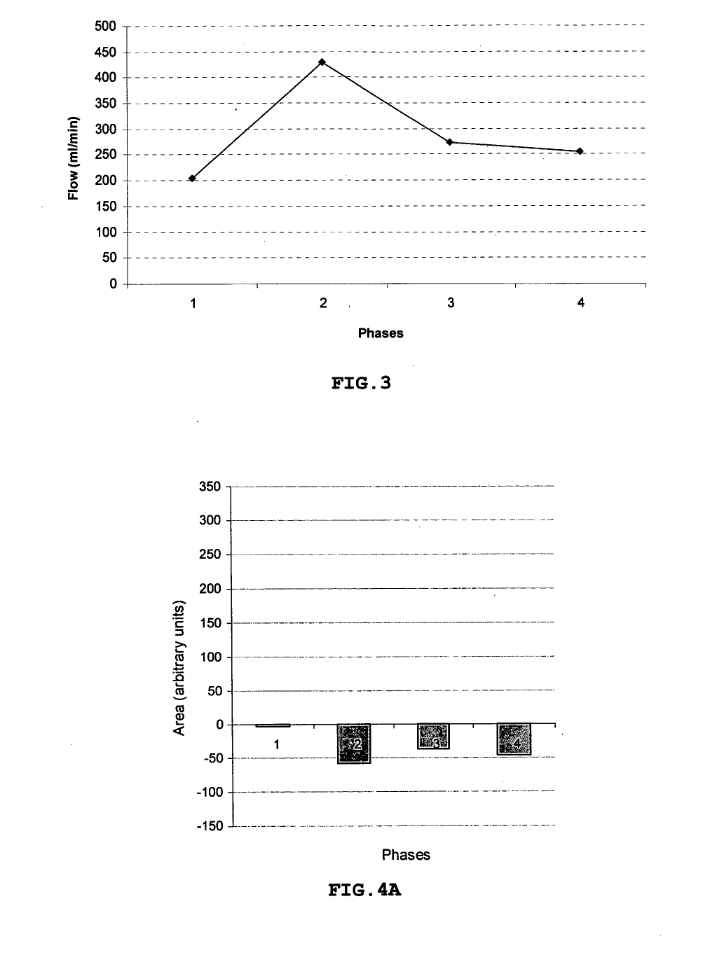

Depending on the phase considered, variable measurements of velocity and flow were detected. The flow trend is represented in FIG. 3.

### NIRS

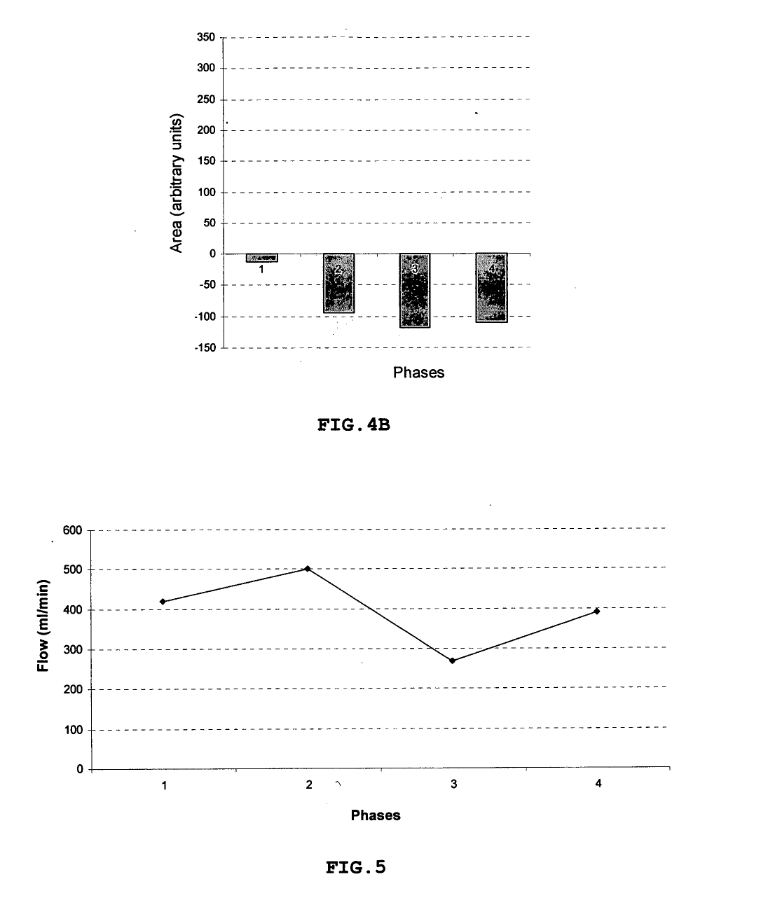

A absence of incrementation of the perfusion area was observed, with modest negativity (negative perfusion area with respect to basal) both in healthy subjects (4 observations) and in affected subjects (7 observations) in all phases subjected to verifying measurement (FIGS. 4a and 4b).

### b) The Device in Continuous Operative Cycle Vs a Traditional Commercially Available Instrument

Analogously, an absence of incrementation with marked negativity of the perfusion area was observed using a conventional instrument.

Such reduction of perfusion was more evident with the traditional instrument with respect to the device object of the present description. The observed values with the two apparatuses in the same subject are shown in FIG. 5.

### Phase 2

### The Prototype in Intermittent Operative Cycle

As for the intermittent cycle, also the therapy proposed in intermittent mode was well tolerated. None of the subjects tested (n=6) reported negative sensations.

### ABI

No variations in ABI measured at rest and after were observed.

### Eco-Color-Doppler

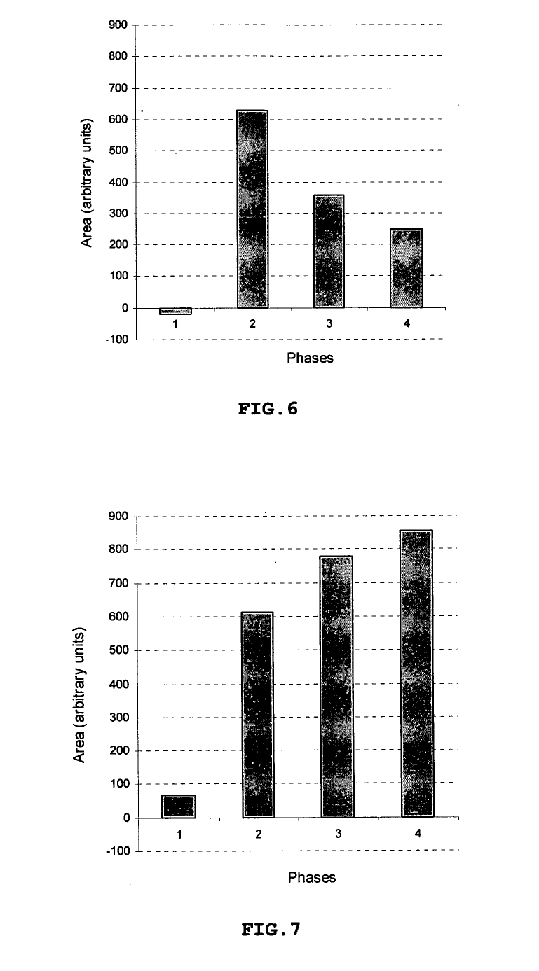

From the observation of the data obtained with Eco-Color-Doppler methodology, a variation of the velocities and of the flows was observed in relation to the various phases considered. The trend is shown in FIGS. 6a and 6b. Unlike in the continuous cycle, a more marked variation was observed between the phase of complete compression and that of complete decompression.

### NIRS

An improvement with respect to the basal values of tissue perfusion measured with NIRS methodology was observed in all phases of the operative cycle (FIG. 6). The comparison, considering the second work period, was at the limit of statistical significance (P=0.05). Such data assumes a high significance considering the reduced number of observations.

The deoxygenated haemoglobin trend (FIG. 7) suggests a greater concomitant peripheral oxygen extraction.

### CONCLUSIONS

Continuous analysis of the HBO₂ trend with NIRS methodology during the use of the device object of the present description in continuous operative cycle showed a perfusion trend that was increasing, to then diminish and become negative starting from the tenth minute, resulting in an observed absence of perfusion during the final analysis.

This observation led the inventor to consider the hypothesis of supplying the intermittent pneumatic compression through cycles of brief duration with a pause period similar to the working one.

Such administration of the delivery allowed better results to be obtained. In fact, the preliminary data collected show that the CPI device object of the present description conceived on the basis of an original haemodynamic approach and used in an intermittent manner, has created variations of the haemodynamic conditions with favourable modification of the perfusion of the ischemic zones and increased the extractive capacity of the local muscular districts. Such data support the assertion that the gradient created by the device object of the present description favours venous efflux from the microcirculation and induces an arterial influx in the distal ischemic district.

Naturally, the details and the embodiments may vary, even widely, with respect to what has been described and illustrated without departing from the scope of the present invention, as defined by the annexed claims.

### BIBLIOGRAFIA

1. Chen A H, Frangos S G, Kilaru S, Sumpio B E. Intermittent Pneumatic Compression Devices—Physiological Mechanisms of Action. Eur J Vasc Endovasc Surg 2001 May; 21(5): 383-92.
2. Labropoulos N, Leon L R Jr, Bhatti A, Melton S, Kang S S, Mansour A M, Borge M. Hemodynamic effects of intermittent pneumatic compression in patients with critical limb ischemia. J Vasc Surg. 2005 October; 42(4):710-6.
3. Delis K T, Husmann M J, Cheshire N J, Nicolaides A N. Effects of intermittent pneumatic compression of the calf and thigh on arterial calf inflow: A study of normals, claudicants, and grafted arteriopaths. Surgery 2001 February; 129(2):188-95.
4. Delis K T, Nicolaides A N, Labropoulos N, Stansby G. The acute effects of intermittent pneumatic foot versus calf versus simultaneous foot and calf compression on popliteal artery hemodynamics: A comparative study. J Vasc Surg. 2000 August; 32(2):284-92.
5. Delis K T, Labropoulos N, Nicolaides A N, Glenville B, Stansby G. Effect of Intermittent Pneumatic Foot Compression on Popliteal Artery Haemodynamics. Eur J Vasc Endovasc Surg 2000 March; 19(3):270-7.
6. McCulloch J M Jr, Kemper C C. Vacuum-compression therapy for the treatment of an ischemic ulcer. Phys Ther. 1993 March; 73(3):165-9.
7. Renner R, Rogalski C, Friedlein H, Simon J C. Vacuum therapy in dermatology: a review. J Dtsch Dermatol Ges. 2006 June; 4(6):468-76.

1. A device for compression treatments of an inferior limb (A) of a subject, said device comprising an inflatable element apt to being placed in contact with a portion of said inferior limb (A) to exert a compression action on said portion of inferior limb (A), characterised in that said inflatable element comprises a rigid element positionable on the medial part of the thigh of said subject for the compression of the superficial femoral vein and/or of the deep veins of the femoral-popliteal segment of said subject.

2. The device according to claim 1, wherein said inflatable element comprises an air chamber associated to said rigid element.

3. The device according to claim 1, wherein said rigid element has a length of 7-15 cm and a width of 7-15 cm.

4. The device according to claim 1, wherein said device comprises a compressor, in fluid communication with said air chamber through a fluid connector, for the supply of a compression fluid to said air chamber.

5. The device according to claim 4, wherein said compressor is provided with means for controlling the delivery of said compression fluid to said air chamber.

6. The device according to claim 4, wherein said compressor is provided with a pressure sensor to measure a flow of said compression fluid delivered to said air chamber.

7. The device according to claim 1, wherein said inflatable element is provided with a fitting in fluid communication with said fluid connector to allow the entrance and exit of said compression fluid in said air chamber.

8. The device according to claim 1, wherein said device comprises means for regulation of the timing of the compression and decompression of said inflatable element.

9. The device according to claim 8, wherein said means for regulation of timing allow the actuation of a work cycle of a duration of 5 minutes with a fixed rhythm of a compression phase of 20 sec duration and a decompression phase of 40 sec duration.
